(19) United States
(12) Patent Application Publication
(10) Pub. No.: US 2007/0279489 A1
(43) Pub. Date: Dec. 6, 2007

(54) DEVICE FOR PROJECTING NIGHTTIME AND DAYTIME IMAGES, ESPECIALLY DURING TRAINING IN HOW TO DRIVE VEHICLES

(75) Inventors: Fontaine Jean-Jacques, Eragny Sur Oise (FR); Frapin Pascal, Cergy (FR)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY SUR SEINE (FR)

(21) Appl. No.: 11/750,817

(22) Filed: May 18, 2007

(30) Foreign Application Priority Data
May 19, 2006 (FR) 06 04509

(51) Int. Cl. G09B 9/00

(52) U.S. Cl. 348/121

(57) ABSTRACT

The present invention relates to a device for projecting nighttime and daytime images, especially during training in how to drive vehicles. The device uses a matrix of micromirrors, comprising a main illumination chain for the matrix and a redundant illumination chain. The redundant illumination chain includes at least one light-filtering means suitable for projecting an image for night vision. The invention may be used within the context of training in driving at night using a light intensifier system, for example night vision goggles.

### BACKGROUND OF THE INVENTION

The present invention relates to a device for projecting nighttime and daytime images, especially during training in how to drive vehicles. This invention may especially be used within the context of training in how to drive at nighttime using a light intensifier system, for example night vision goggles.

### PRIOR ART

Training in how to drive a terrestrial vehicle or how to fly an aircraft using a light intensifier system for example under really dark nighttime conditions may be carried out using means for simulating the environment, which means are advantageously less expensive and simpler to implement than actual conditions. However, it is necessary to reconstruct the environment, and especially the perception of nighttime images, as faithfully as possible. For this purpose, several simulation systems have been developed.

Firstly there is a simulation system that simulates the function of light intensifiers which consists in replacing the latter with a micromonitor on which a synthetic image is displayed, said image being calculated in such a way that the image observed on the micromonitor has the same rendering as the actual image seen through light intensifiers. This solution is expensive to implement as it requires a commitment to manufacture a specific system. This system must reproduce the special effects associated with light intensifiers, such as automatic gain control, halos and noise. However, it must also incorporate a device for detecting the position of the head so as to display the images corresponding to the direction of observation in order to take into account, as faithfully as possible, regions concealed in the real world, for example by the presence of a windshield upright.

Another system uses a stimulation of the real light intensifier system by generating an image which, when observed using the light intensifier system gives the same result as if the images observed derive from real environment. The difficulty lies in producing images with good contrast and a perfect black level, and in particular in retaining images of lights that are bright enough in the presence of dark environment. These conditions are fulfilled by systems using projectors made up of cathode ray tubes. This is because cathode ray tubes have a large brightness dynamic range with, in particular, a very deep black. This system has been described for example in French patent application 98/14983. However, systems based on cathode ray tubes are difficult to control and are expensive both in terms of purchase costs and maintenance costs. In addition, cathode ray tubes are becoming less and less widespread and are being replaced with less expensive technologies that require little maintenance and few specific adjustments, such as projectors based on micromirrors. Furthermore, cathode ray tubes have the drawback of inferior luminosity performance, to the detriment of the use of such a system for the purpose of training in daytime driving. However, the use of projectors based on micromirrors, although giving very good results in respect of the rendering of scene in daytime, is ill suited for scenes at night owing to poor image contrast and too deep a black level. Such projectors are therefore not well suited for training in nighttime driving.

### SUMMARY OF THE INVENTION

The object of the invention is in particular to alleviate the aforementioned drawbacks. For this purpose, the subject of the invention is an image projecting device using a matrix of micromirrors, comprising a main illumination chain for the matrix and a redundant illumination chain, in which the redundant illumination chain includes at least one light-filtering means suitable for projecting an image for night vision.

The main chain is for example inhibited.

The redundant chain may be composed of a light source and a wheel containing filters.

The wheel containing filters of the redundant chain is for example adapted so as to reduce the transmission of light in the wavelengths intensified by the vision system.

In another embodiment, the wheel containing filters is composed of two apertures of each of the following colors: red, green and blue, one of the red apertures being provided with a gray filter and the second aperture being masked.

In another embodiment, the wheel containing filters has, for example, four apertures for the colors red, green, blue and white, the red and white colors being attenuated by a gray filter.

The wheel containing filters may also have three apertures for the colors red, green and blue, only the red color being attenuated by the addition of a gray filter.

Advantageously, the wheel containing filters may be used for scotopic vision, and is then adapted by adding a gray filter to each of the colors of the wheel, the adapted filter for the red color being darker than for the other colors.

The invention has in particular four advantages: it can be fitted to existing equipment; it is inexpensive; it is simple to implement; and is simple to use.

### BRIEF DESCRIPTION OF THE DRAWINGS

Other features and advantages of the invention will become apparent from the following description, in conjunction with the appended drawings which show:

FIG. 1: an example of simulation for training in nighttime driving;

FIG. 2: the principle of a projector based on micromirrors;

FIG. 3: the principle of reflection off micromirrors;

FIG. 4: the wavelength plot for the light to be treated for simulation; and

FIG. 5: a projection device based on micromirrors employed within the context of the invention.

### DESCRIPTION OF THE PREFERRED EMBODIMENTS

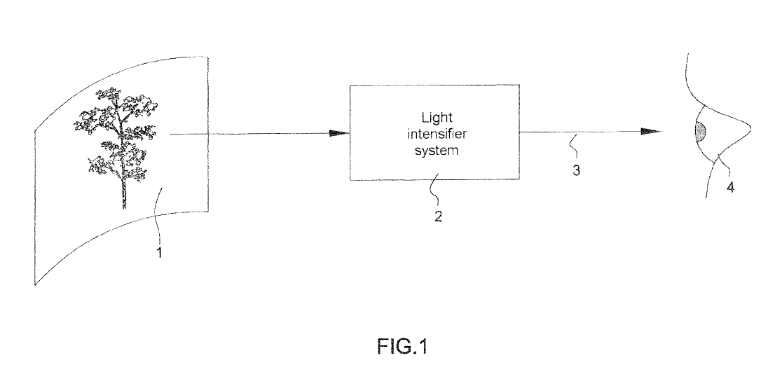

FIG. 1 shows an example of simulation used for training in nighttime driving using a light intensifier system, such as for example nighttime vision goggles. The objective of the simulation system is to project a image 1, perceived at the inlet of a light intensifier 2. In the example shown in FIG. 1, the image 1 reproduces a scene at night. The intensifier 2 generates, as output, a light signal 3 intended for an observer 4, this signal reproducing the intensified image. The synthesized image 2 produced by the device is projected on a screen, which may be spherical or cylindrical and allows the observer to perceive the scene on the periphery of the light intensifier. The image may therefore reproduce, in a realistic manner, the external scene but also the immediate environment of the observer, such as, for example, the structure of the vehicle in which he is in. Within the context of the invention, the synthesized image is generated by a projector based on micromirrors.

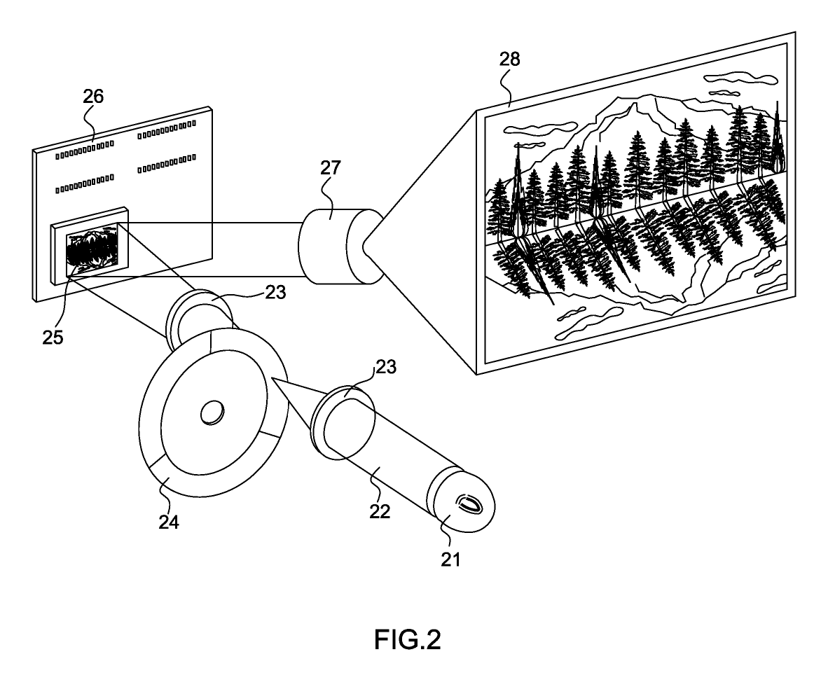

FIG. 2 illustrates the general principle of a projector based on micromirrors. This device is made up of a light source 21 which emits a monochromatic light beam 22 onto a lens system 23 which makes the image converge on a wheel containing filters 24, for example made up of six apertures for the colors red, green and blue, each repeated twice, so that the observer's eye is unable to recognize the passing of one color to another, without the need to increase the speed of rotation of the wheel. This wheel containing filters 24 rotates synchronously with the display of the image produced by the synthesized image generator 25 on the matrix 26 of micromirrors of the projector. This image is then reflected by the micromirrors onto a lens 27 before being projected onto a screen 28. Each micromirror of the projector allows the images relating to each color to be projected sequentially, the color being determined by the position of the wheel containing filters relative to the light beam. The wheel containing filters is conventionally made up of three color filters, for the colors red, green and blue. A relatively wide white sector may also be added to the wheel so as to increase the luminosity, to the detriment of lower saturation of the colors. The wheel containing filters may also consist of six openings, allowing the red, blue and green colors to be repeated twice, thereby making it possible to display the red, green, blue cycle twice as rapidly without having to double the speed of the wheel. This also makes the transition between images of different colors invisible to the eye.

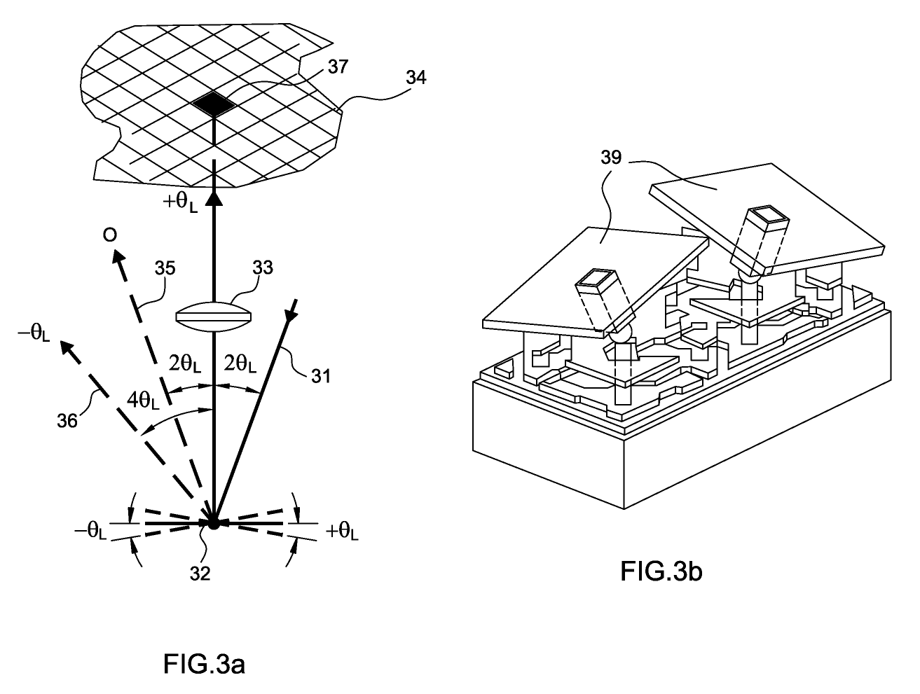

FIGS. 3a and 3b show the micromirror reflection device 39. The matrix of micromirrors is used to reflect the light filtered beforehand by the wheel containing filters onto the screen. The micromirrors of the matrix may be oriented independently of one another. Their orientation depends in a known manner on the calculated image to be displayed. Thus, each micromirror can adopt several positions:
a position corresponding to an angle +θ_{L} to the horizontal, which allows the received light ray 31 to be reflected onto the projection mirror 33 in order to give a point 37 of the image 34;
a position corresponding to the angle −θ_{L} to the horizontal, which makes it possible to reflect the received light ray 31 onto a light trap, the ray in this case making no contribution to the displayed image; and
a rest position corresponding to the zero angle.
   This device makes it possible to vary the time during which the mirror is in the position for reflecting the light through the optic: the shorter the time, the darker the resulting image. Thus, to render a nighttime image, the reflection times of the micromirrors may be reduced complementarily to the filtering performed by the wheel containing filters.

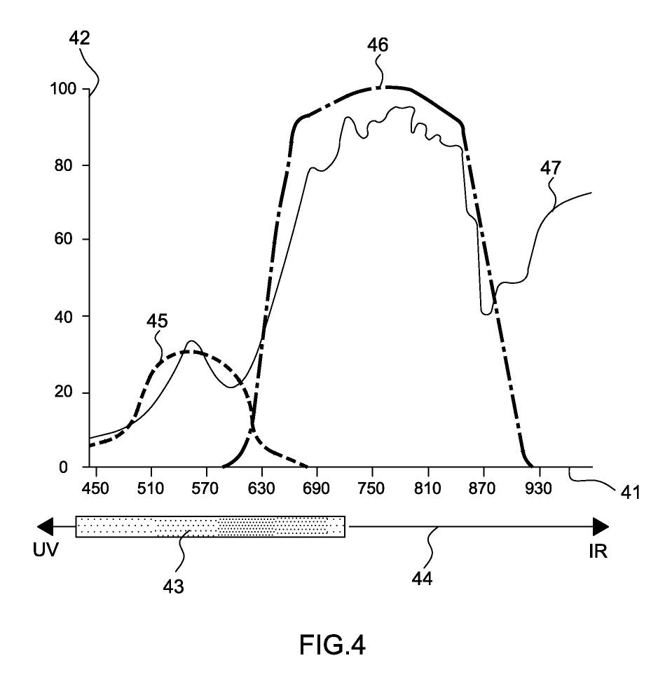

FIG. 4 illustrates the spectrum of the light emitted by a scene in respect of the sensitivities associated with the various types of sensor involved, namely the human eye and nighttime vision goggles. In the graph shown in FIG. 4, the x-axis 41 is graduated as the wavelength of the light emitted. This wavelength varies within the visible spectrum 43 from blue to red and then passes into the infrared spectrum 44. The y-axis 42 shows the response of the various sensors used as the spectrum 47 of light emitted by a scene. A first curve 45 represents the photopic vision, and therefore the light captured by a human eye in day light. A second curve 46 shows the light captured by nighttime vision goggles over the various wavelengths. These two curves 45 and 46 show that nighttime vision goggles are much more sensitive to wavelengths lying within the red and at the infrared limits whereas the human eye itself is more sensitive at wavelengths close to the blue during daytime vision called photopic vision, and close to the green during nighttime vision, called scotopic vision. Within the context of simulating a nighttime scene, it is therefore necessary to reduce the level of light transmission in the wavelengths corresponding to red and to infrared so as not to have an image representing, for example, lights that are too bright compared with the rest of the scene in the goggles, which would make the image difficult to interpret. However, the wavelengths from blue to green may remain unchanged, not being perceived by the goggles but only by the eye in peripheral vision of the goggles. Level of transmission for a given wavelength is modified by means of the wheel containing filters, by placing an optical filter matched to the desired level of transmission in front of the filter for the appropriate color. In addition to modifying the transmission in a given wavelength, so as to darken the image, it is possible to add a gray or density filter in front of each of the colors on the wheel containing filters. To give an example, in the case of a wheel containing filters having six apertures, the first red filter is provided with a neutral density, the corresponding radiation then being completely transmitted, and the second red filter is replaced either with a mask or with a dark gray filter, the other filters remaining unchanged.

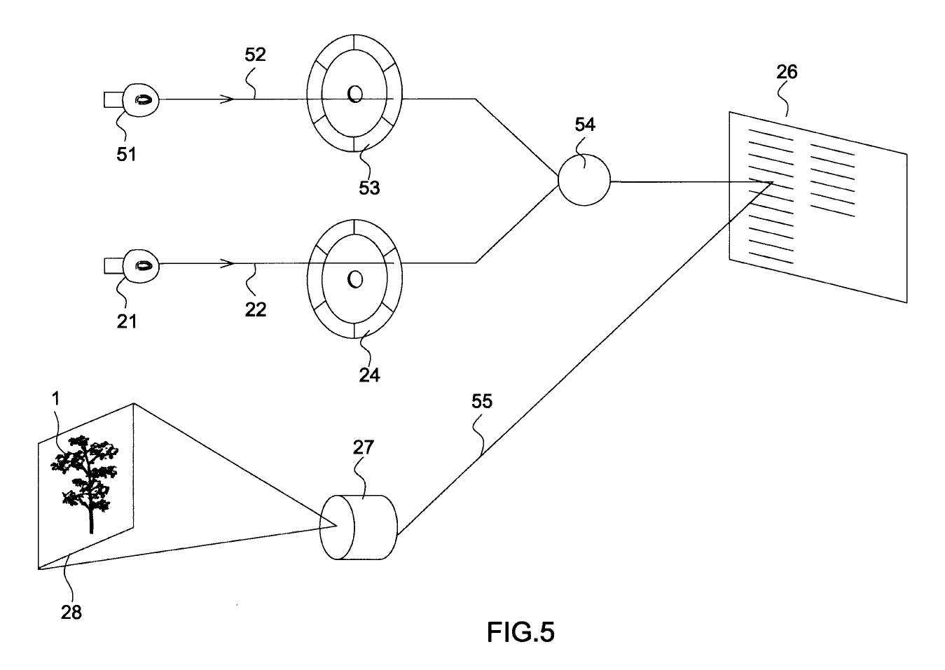

FIG. 5 shows a projection device according to the invention. In the projectors commonly used, the main projection chain illustrated in FIG. 2 is in fact duplicated with a redundant second chain. This second chain is made up of a lamp 51, allowing the overall luminosity of the device to be increased, and a wheel containing filters 53, which makes it possible to mitigate for the limited lifetime of the wheels containing filters. Thus, the projector based on micromirrors is provided with two lamps 21 and 51, two wheel containing filters 24 and 53 and a switch 54. The light is then conventionally directed onto the matrix 26 of micromirrors of the projection device according to the invention so as to be converted into an image and projected via the lens 27 onto the screen 28.

In normal operation, the second or redundant chain is inhibited. It may also be activated so as to intensify the luminosity of the projected image, for example for a daytime scene. It is obviously also used to replace the main chain should the latter become defective. This redundant chain therefore has the objective of reinforcing the main chain or of replacing it in the event of failure.

In the present invention, the device employed advantageously uses the two chains both for simulations of daytime situations and for simulations of nighttime situations. This is because one of the two chains, for example that made up of the lamp 23 and the filter 24, may be used as means for projecting a daytime scene and the second chain, made up of the lamp 51 and the filter 53, may be used to project a nighttime scene, as seen by nighttime vision goggles for example. The filter 53 is then designed to optimize the signal perceived by the nighttime vision goggles, for example as in the case of the six-aperture filter described with regard to FIG. 4.

Switching between projection of a nighttime scene and projection of a daytime scene is therefore astutely carried out by inhibiting, for example, the projection chain 21, 22, 23 and by activating the projection chain 51, 52, 53 by means of the switch 54.

The filter of the second chain may, depending on the requirements, also be replaced with a four-aperture filter. Again to adapt an image to vision through nighttime vision goggles, the red filter of the wheel is provided with a neutral density, the green and blue filters remain unchanged, while the white filter is replaced with a neutral gray filter so as to reduce the luminosity. In the same way, a three-aperture filter may possibly be adapted by adding a gray filter to the red filter so as to reduce the transmission in this wavelength, the other filters remaining unchanged.

In other uses of the invention, the filter placed in the second chain may advantageously be adapted not to a nighttime scene, as seen using a light intensifier but to scotopic vision of a nighttime scene, that is to say as seen by the eye. This filter may for example have three openings, for the colors red, green and blue. In the case of nighttime vision, owing to the fact that the eye is more sensitive to short wavelengths, the transmission of light in the wavelength corresponding to red is attenuated by a gray filter. In addition, all the colors are attenuated uniformly so as to take account of the general low luminosity of the scene.

One advantage of the invention is that it fits perfectly and inexpensively to already existing projectors. Moreover, the device according to the invention is simple to implement since all that is required is to change the filter used in the redundant chain with a specific filter suitable for use for the projection of nighttime images.

Another advantage of the invention is that it allows simplified use of the simulation system in that there is no specific and complex adjustment to be made in order to use the projector, either to project a nighttime image or to project a daytime image. It is thus possible to switch easily from one simulation mode to the other.

1. An image projection device, comprising:
a matrix of micromirrors, a main illumination chain for the matrix and a redundant illumination chain for the matrix, wherein the redundant illumination chain includes at least one light-filtering means suitable for projecting an image for night vision.

2. The device as claimed in claim 1, wherein the main chain is inhibited.

3. The device as claimed in claim 1, wherein the redundant chain is composed of a light source and a wheel containing filters.

4. The device as claimed in claim 1, wherein the wheel containing filters of the redundant chain is adapted so as to reduce the transmission of light in the wavelengths intensified by a vision system.

5. The device as claimed in claim 4, wherein the wheel containing filters is composed of two apertures of each of the following colors: red, green and blue, one of the red apertures being provided with a gray filter and the second aperture being masked.

6. The device as claimed in claim 4, wherein the wheel containing filters has four apertures for the colors red, green, blue and white, the red and white colors being attenuated by a gray filter.

7. The device as claimed in claim 1, wherein the wheel containing filters has three apertures for the colors red, green and blue, only the red color being attenuated by the addition of a gray filter.

8. The device as claimed in claim 1, wherein the wheel containing filters used for scotopic vision is adapted by adding a gray filter to each of the colors of the wheel, the adapted filter for the red color being darker than for the other colors.

9. The device as claimed in claim 2, wherein the redundant chain is composed of a light source and a wheel containing filters.

10. The device as claimed in claim 2, wherein the wheel containing filters of the redundant chain is adapted so as to reduce the transmission of light in the wavelengths intensified by a vision system.

11. The device as claimed in claim 3, wherein the wheel containing filters of the redundant chain is adapted so as to reduce the transmission of light in the wavelengths intensified by a vision system.

12. The device as claimed in claim 2, wherein the wheel containing filters has three apertures for the colors red, green and blue, only the red color being attenuated by the addition of a gray filter.

13. The device as claimed in claim 2, wherein the wheel containing filters used for scotopic vision is adapted by adding a gray filter to each of the colors of the wheel, the adapted filter for the red color being darker than for the other colors.
